(19) United States
(12) Patent Application Publication
(10) Pub. No.: US 2008/0092864 A1
(43) Pub. Date: Apr. 24, 2008

(54) Blowby gas passage structure

(75) Inventors: Koichi Suzuki, Obu-shi (JP); Katsumi Ishida, Toyoake-shi (JP); Keiso Takeda, Nagoya-shi (JP); Hiroshi Asanuma, Chita-shi (JP)

Correspondence Address: OLIFF & BERRIDGE, PLC, P.O. BOX 320850, ALEXANDRIA, VA, 22320-4850, US

(73) Assignee: AISAN KOGYO KABUSHIKI KAISHA, OBU-SHI (JP)

(21) Appl. No.: 11/905,086

(22) Filed: Sep. 27, 2007

(30) Foreign Application Priority Data
Oct. 24, 2006 (JP) 2006-288381

(51) Int. Cl. F02B 25/06

(52) U.S. Cl. 123/574

(57) ABSTRACT

A blowby gas passage structure for returning a blowby gas leaking into a crankcase of an internal combustion engine to the internal combustion engine comprises: an intake passage which can be connected to the internal combustion engine for allowing the blowby gas to be returned to the internal combustion engine, and in which a throttle valve is disposed; a first passage for allowing the blowby gas to be introduced into the intake passage downstream from the throttle valve, the first passage including a joint portion connected to the intake passage; and a heating device provided in the joint portion of the first passage in such a manner as to be integral with the intake passage.

### BACKGROUND OF THE INVENTION

1. Field of the Invention

The present invention relates to a blowby gas passage structure for returning a blowby gas to an internal combustion engine through an intake passage.

2. Description of Related Art

Heretofore, an engine for motor vehicle includes a blowby gas returning device (PCV: Positive Crankcase Ventilation) arranged to return a blowby gas, which has leaked into a crankcase of the engine mostly through gaps between a cylinder and a piston, to the engine via an intake manifold so that-the blowby gas burns again.

This blowby gas has a high content of water (water vapor) generated by the combustion. Accordingly, in the case where the outside air temperature falls below 0° C. in winter, the water tends to freeze, clogging a blowby gas passage. Clogging of the blowby gas passage may cause the pressure in the engine to increase, leading to such disadvantages that an oil level gage comes off, oil scatters, oil leaks from a crank oil sealing part, and so on. Thus, various measures have been adopted against freezing of water in the blowby gas.

In one of the measures, a resin union with heater unit made by insert-molding a film heater in an inner wall is attached to an intake passage, thereby preventing freezing of water contained in the blowby gas introduced into the intake passage (JP2001-214995A).

However, in the above configuration, the intake passage and the union with heater unit are separately provided. This configuration needs a process of adapting the intake passage for allowing the union to be attached thereto and another process of attaching the union to the intake passage. Consequently, the number of processes for assembly is increased, which causes disadvantages in productivity and cost.

JP2001-214995A does not clearly describe an attachment place of the union, but it is conceivable that the union is located upstream from a throttle valve and forms the blowby gas passage (see FIG. 8 of JP2001-214995A). Accordingly, the union could prevent freezing of the water in the blowby gas to avoid clogging of the passage. However, the union cannot remove water from the blowby gas and thus such water is likely to adhere to the throttle valve. The throttle valve may freeze due to the water adhered thereto. That is, there is a problem that the water in the blowby gas could not completely be prevented from freezing.

### BRIEF SUMMARY OF THE INVENTION

The present invention has an object to provide a blowby gas passage structure capable of preventing freezing of water in a blowby gas, thereby avoiding clogging of a passage and freezing of a throttle valve.

To achieve the above object, one aspect of the present invention provides a blowby gas passage structure for returning a blowby gas leaking into a crankcase of an internal combustion engine to the internal combustion engine, the blowby gas passage structure comprising: an intake passage which can be connected to the internal combustion engine for allowing the blowby gas to be returned to the internal combustion engine, and in which a throttle valve is disposed; a first passage for allowing the blowby gas to be introduced into the intake passage downstream from the throttle valve, the first passage including a joint portion connected to the intake passage; and a heating device provided in the joint portion of the first passage in such a manner as to be integral with the intake passage.

According to another aspect, the present invention provides a blowby gas passage structure for returning a blowby gas leaking into a crankcase of an internal combustion engine to the internal combustion engine, the blowby gas passage structure comprising: an intake passage which can be connected to the internal combustion engine for allowing the blowby gas to be returned to the internal combustion engine; a throttle body having a bore in which a throttle valve is housed; a first passage for allowing the blowby gas to be introduced into the intake passage downstream from the throttle valve; a second passage for allowing ventilating air to be introduced from the intake passage upstream of the throttle valve to the crankcase; a through hole formed opening in a side surface of the throttle body and communicating with the bore; and a heating device for heating the throttle body; one end of the first passage being connected to the through hole to introduce the blowby gas from the bore to the intake passage through the through hole.

### BRIEF DESCRIPTION OF THE DRAWINGS

FIG. 1 is a schematic configuration view of an engine system of a first embodiment;

FIG. 2 is an external view schematically showing an intake manifold;

FIG. 3 is a sectional view schematically showing a blowby gas introducing part in the intake manifold;

FIG. 4 is a sectional view schematically showing a check valve provided in a PCV air passage;

FIG. 5 is an explanatory view showing a state in which the check valve of FIG. 4 is in operation (a back-flow prevention state);

FIG. 6 is a sectional view schematically showing a first modified example of the blowby gas introducing part;

FIG. 7A is a sectional view schematically showing a second modified example of the blowby gas introducing part;

FIG. 7B is a sectional view of the blowby gas introducing part of FIG. 7A, taken along a line A-A;

FIG. 8A is a sectional view schematically showing another example of the second modified example of the blowby gas introducing part;

FIG. 8B is a sectional view of the blowby gas introducing part of FIG. 8A, taken along a line A-A;

FIG. 9A is a sectional view schematically showing another example of the second modified example of the blowby gas introducing part;

FIG. 9B is a sectional view of the blowby gas introducing part of FIG. 9A, taken along a line A-A;

FIG. 10 is a front view schematically showing a throttle control apparatus;

FIG. 11 is an external view of the throttle control apparatus of FIG. 10, seen from below; and

FIG. 12 is a partial sectional view of the throttle control apparatus of FIG. 11, taken along a line A-A.

### DETAILED DESCRIPTION OF THE PREFERRED EMBODIMENTS

### First Embodiment

A detailed description of a preferred embodiment of a blowby gas passage structure embodying the present invention will now be given referring to the accompanying drawings.

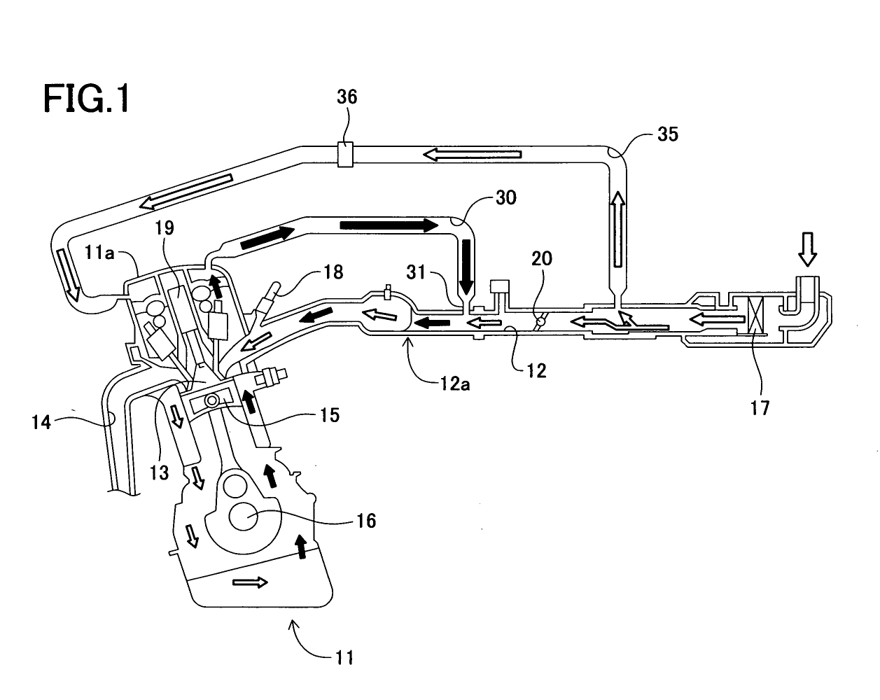

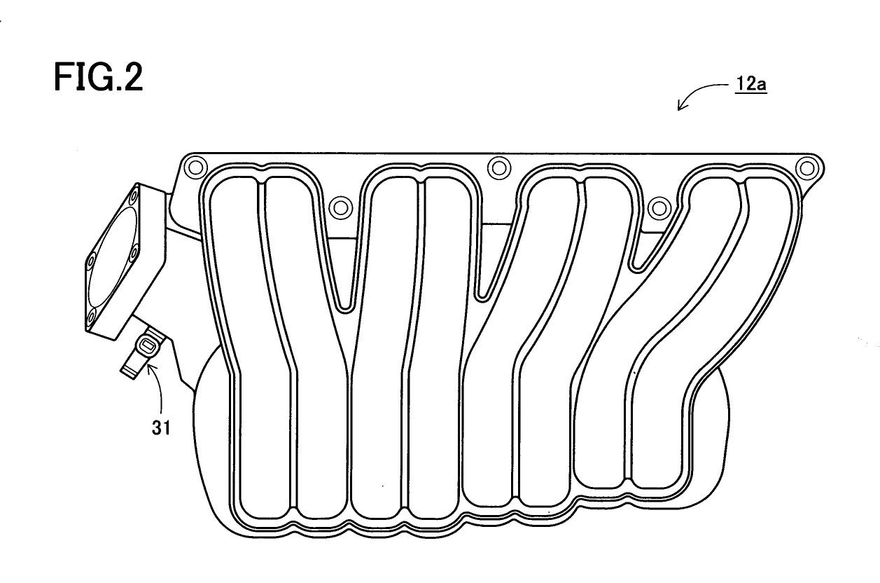

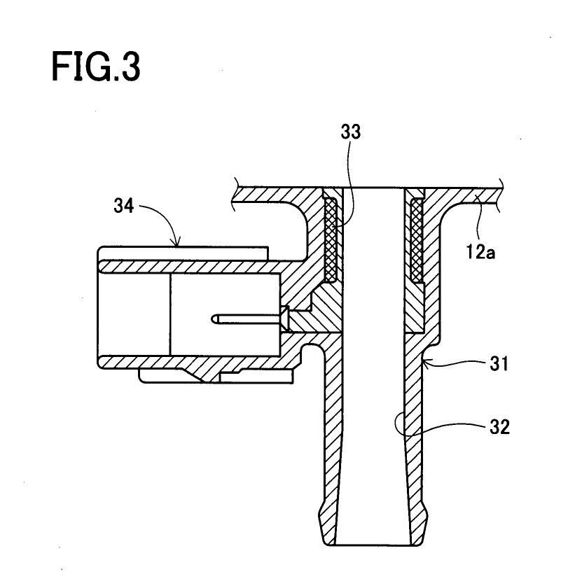

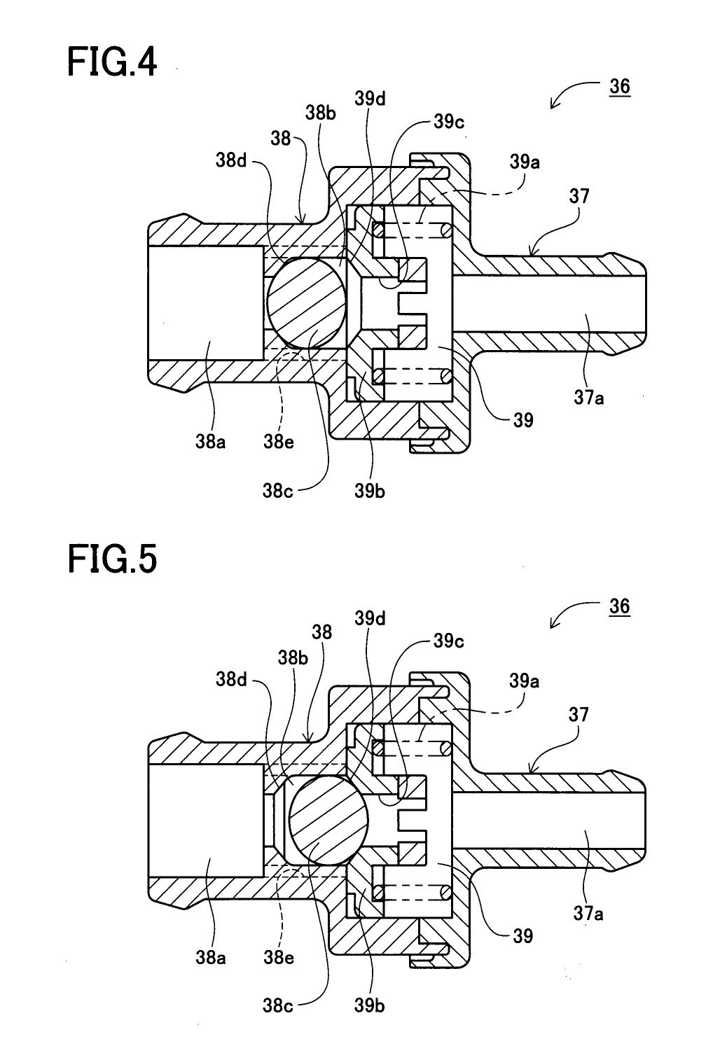

An engine system adopting the blowby gas passage structure of the present invention will be described below referring to FIGS. 1 through 4. FIG. 1 is a schematic configuration view of the engine system of a first embodiment. FIG. 2 is an external view schematically showing an intake manifold. FIG. 3 is a sectional view schematically showing a blowby gas introducing part of the intake manifold. FIG. 4 is a sectional view schematically showing a check valve provided in a PCV air passage.

An engine 11 in this system is a reciprocating engine having a well known structure. The engine 11 is arranged to explode and burn fuel and air, i.e., an air-fuel mixture, supplied into a combustion chamber 13 through an intake passage 12, and then discharge exhaust gas resulting from the combustion to the outside of the engine 11 through an exhaust passage 14, thereby driving a piston 15 to rotate a crank shaft 16, thus generating power.

An air cleaner 17 is located in the intake passage 12 to clean the air to be taken in the intake passage 12. A throttle valve 20 placed in the intake passage 12 is operated to control an amount of air (an intake air amount) which will flow through the intake passage 12 and be sucked in the combustion chamber 13.

An injector 18 placed around an intake port communicating with the combustion chamber 13 is configured to inject fuel supplied from a fuel supply system not shown, into the intake port. The fuel injected into the intake port by operation of the injector 18 is mixed with the air flowing through the intake passage 12, forming a combustible air-fuel mixture, and this mixture is taken in the combustion chamber 13.

An ignition plug 19 is mounted in the engine 11 in correspondence with the combustion chamber 13 to ignite the combustible air-fuel mixture taken in the combustion chamber 13. This ignition plug 19 can generate sparks upon receipt of a high voltage outputted from an ignition coil not shown. The sparking of the ignition plug 19 explodes and burns the combustible air-fuel mixture sucked in the combustion chamber 13. Exhaust gas resulting from burning or combustion is exhausted to the outside from the combustion chamber 13 via an exhaust port and an exhaust passage 14. As the combustible air-fuel mixture burns in the combustion chamber 13, the piston 15 is moved up and down, thereby rotating the crank shaft 16, thus generating power in the engine 11.

Here, part of the fuel gas can mostly leak through gaps between the piston 15 and a cylinder into a crankcase. To return the blowby gas leaking into the crankcase to the combustion chamber 13 through the intake manifold 12a to burn the blowby gas again, a PCV negative pressure passage 30 is arranged to provide communication between a head cover 11a and the intake passage 12. This PCV negative pressure passage 30 is connected to part of the intake passage 12 downstream from the throttle valve 20. More precisely, the PCV negative pressure passage 30 is connected to the intake manifold 12a.

The intake manifold 12a to which the PCV negative pressure passage 30 is connected is formed with a joint 31 for connection with the PCV negative pressure passage 30. This joint 31 includes a cylindrical port 32, a heater 33 built in the port 32 on the side of the intake manifold, and a connector 34 for connecting the heater 33 to a power source. The heater 33 and the connector 34 constitute a heater unit of the present invention. The joint 31 is provided integral with the intake manifold 12a. Accordingly, unlike a conventional one, the heater unit of the present embodiment does not need to be assembled in the intake manifold 12a, resulting in a reduced number of assembling processes. Since the heater unit is provided integral with the intake manifold 12a defining a part of the intake passage, the heater unit can have enhanced strength and improved reliability, and also a cost advantage.

As the heater 33, a coil wire capable of generating heat upon application of an electric current thereto is used. Use of such a simple heater can achieve a reduction in cost and an improvement in reliability of the heater unit.

Further, a PCV air passage 35 is arranged to provide communication between the head cover 11a and the intake passage 12. This PCV air passage 35 serves to guide ventilating air (atmosphere) from the intake passage 12 into a crankcase in order to prevent blowby gas from remaining in the crankcase. By the ventilating air introduced into the crankcase through the PCV air passage 35, the blowby gas in the crankcase is allowed to smoothly circulate through the PCV negative pressure passage 30 and the intake passage 12 to return to the combustion chamber 13. In some midpoint of this PCV air passage 35, a check valve 36 is installed for blocking the flow of a fluid from the engine 11 to the intake passage 12.

This check valve 36 includes, as shown in FIG. 4, an inflow body 37 formed with an inflow port 37a, and an outflow body 38 formed with an outflow port 38a and a valve chamber 38b communicating with the outflow port 38a. The inflow body 37 and the outflow body 38 are connected to each other, forming a communication passage 39 which provides communication between the valve chamber 38b and the inflow port 37a. In the valve chamber 38b, a ball-shaped first valve element 38c is movably disposed. A first valve seat 38d is formed in a communicating area between the valve chamber 38b and the outflow port 38a. Further, a flow path 38e is formed in the outflow body 38 outwardly of the valve chamber 38b. In the communication passage 39, a second valve element 39b is fitted in such a manner as to be urged toward the valve chamber 38b by a spring 39a. The second valve element 39b is centrally formed with a through hole 39c and a second valve seat 39d around the through hole 39c in such a manner as to face the valve chamber 38b.

In the above check valve 36, when a fluid flows in the inflow port 37a, the first valve element 38c is brought into contact with the first valve seat 38d, thereby closing communication between the valve chamber 38b and the outflow port 38a, whereas the valve chamber 38b and the outflow port 38a are allowed to communicate with each other through the flow path 38. This allows the fluid flowing in the inflow port 37a to pass through the communication passage 39, the through hole 39c, the valve chamber 38b, and the flow path 38e, and flow in the outflow port 38a. To the contrary, when a fluid flow in the outflow port 38a, the first valve element 38c is brought into contact with the second valve seat 39d, closing the communication of the valve chamber 38b and the flow path 38e with the communication passage 39. Thus, the fluid flowing in the outflow port 38a is not allowed to flow in the communication passage 39.

In the PCV air passage 35 provided with the check valve 36, therefore, the atmosphere flowing therein from the intake passage 12 is allowed to pass through the check valve 36 and be introduced into the crankcase. When the blowby gas flows in the PCV air passage 35, on the other hand, the blowby gas is not allowed to pass through the check valve 36 and thus cannot flow in the intake passage 12. In case the pressure in a pipe connected to the outflow port 38a abnormally rises, the pipe may be damaged or disconnected from the check vale 36. To avoid such defects, the check valve 36 has a fail-safe system that moves the second valve element 39b toward the outflow port against the urging force of the spring 39a to allow a fluid to flow from the outflow port 38a to the inflow port 37a.

Next, the flow of blowby gas in the above engine system will be explained below. After the engine 11 starts, the blowby gas leaking into the crankcase will pass through the PCV negative pressure passage 30 connected to the head cover 11a and then flow in the intake manifold 12a via the port 32 of the joint 31. At this time, ventilating air is delivered from the intake passage 12 to the crankcase through the PCV air passage 35. Accordingly, the blowby gas in the crankcase is caused to smoothly flow in the intake manifold 12a through the PCV negative pressure passage 30. Then, the blowby gas flowing in the intake manifold 12a is supplied along with the combustible air-fuel mixture into the combustion chamber 13 and burns therein again.

Here, the blowby gas has a high content of water generated by combustion. When an outside air temperature falls below 0° C. in winter for example, the water is apt to freeze, clogging the PCV negative pressure passage 30.

In the present embodiment, however, the blowby gas introduced into the intake manifold 12a via the PCV negative pressure passage 30 is heated by the heater 33 while passing through the port 32 of the joint 31. This makes it possible to prevent the water in the blowby gas from freezing and hence avoid clogging of the PCV negative pressure passage 30 due to the freezing of the blowby gas.

The blowby gas is returned to the intake manifold 12a, i.e., to the intake passage 12 downstream from the throttle valve 20. Accordingly, the blowby gas is unlikely to adhere to the throttle valve. Freezing of the throttle valve due to the water in the blowby gas can therefore be prevented.

In case the PCV negative pressure passage 30 is clogged from any cause, increasing the pressure in the crankcase, the blowby gas is likely to flow in (back flow in) the intake passage 12 upstream from the throttle valve 20 through the PCV air passage 35. The blowby gas likely adheres to the throttle valve 20 and the water in the blowby gas may cause freezing of the throttle valve 20 when the outside air temperature falls below 0° C. in winter for example.

In the present embodiment, however, the PCV air passage 35 is provided with the check valve 36 for blocking the flow of a fluid from the head cover 11a to the intake passage 12. When the blowby gas flows in the PCV air passage 35, therefore, the first valve element 38c is made contact with the second valve seat 39d as shown in FIG. 5. FIG. 5 is an explanatory view showing the check valve in operation (a back-flow prevention state).

When the first valve element 38c is brought into contact with the second valve seat 39d, the communication of the valve chamber 38b and the flow path 38e with the communication passage 39 is closed. Thus, the blowby gas flowing in the outflow port 38a is not allowed to flow in the communication passage 39. The blowby gas therefore cannot pass through the check vale 36. Even where the blowby gas flows in the PCV air passage 35, the blowby gas cannot flow in the intake passage 12 through the PCV air passage 35. As a result, the blowby gas is always returned to the intake passage 12 (specifically, the intake manifold 12a) downstream from the throttle valve 20, so that the blowby gas is unlikely to adhere to the throttle valve 20. Freezing of the throttle valve 20 due to the water in the blowby gas can also be prevented reliably.

According to the engine system of the first embodiment, as described above, the blowby gas is returned to the intake manifold 12a through the PCV negative pressure passage 30. In the joint 31 integral with the intake manifold 12a, connected to the PCV negative pressure passage 30, the heater 33 and the connector 34 are provided. The blowby gas is heated by the heater 33 at the time of returning to the intake manifold 12a. This makes it possible to prevent the water in the blowby gas from freezing, thereby preventing the PCV negative pressure passage 30 from becoming clogged by the freezing of the blowby gas.

The blowby gas heated is returned to the intake manifold 12a, that is, to the intake passage 12 downstream from the throttle valve 20. Further, the check valve 36 placed in the PCV air passage 35 can surely blocks the blowby gas from flowing in the intake passage 12 even when the blowby gas flows in (back flows in) the PCV air passage 35. In this regard, the blowby gas is unlikely to adhere to the throttle valve and therefore the throttle valve can be prevented from freezing due to the water in the blowby gas.

Moreover, the joint 31 integrally including the heater 33 and the connector 34 is formed with the intake manifold 12a by integral molding. There is no need for individually assembling a heater, a joint, and others to the intake manifold, with the result that the number of assembling processes can be reduced.

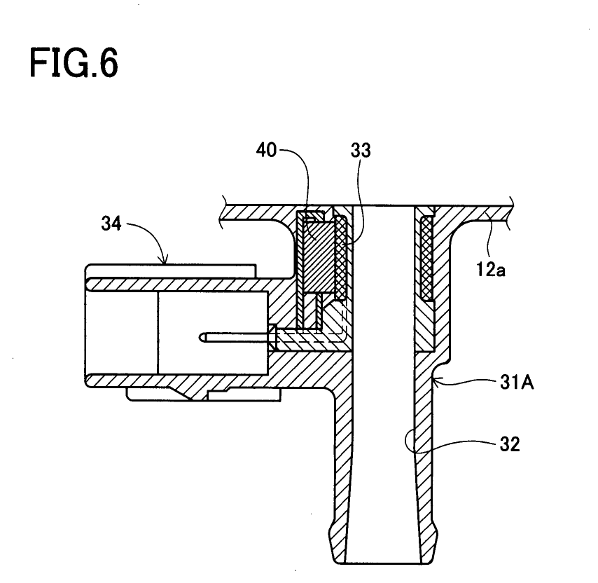

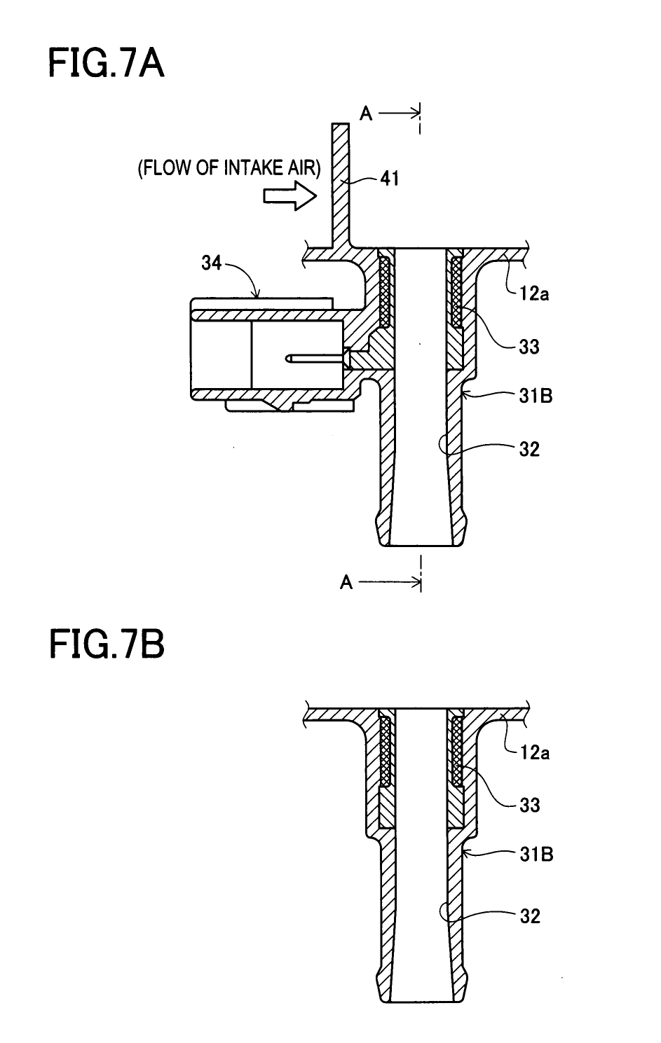

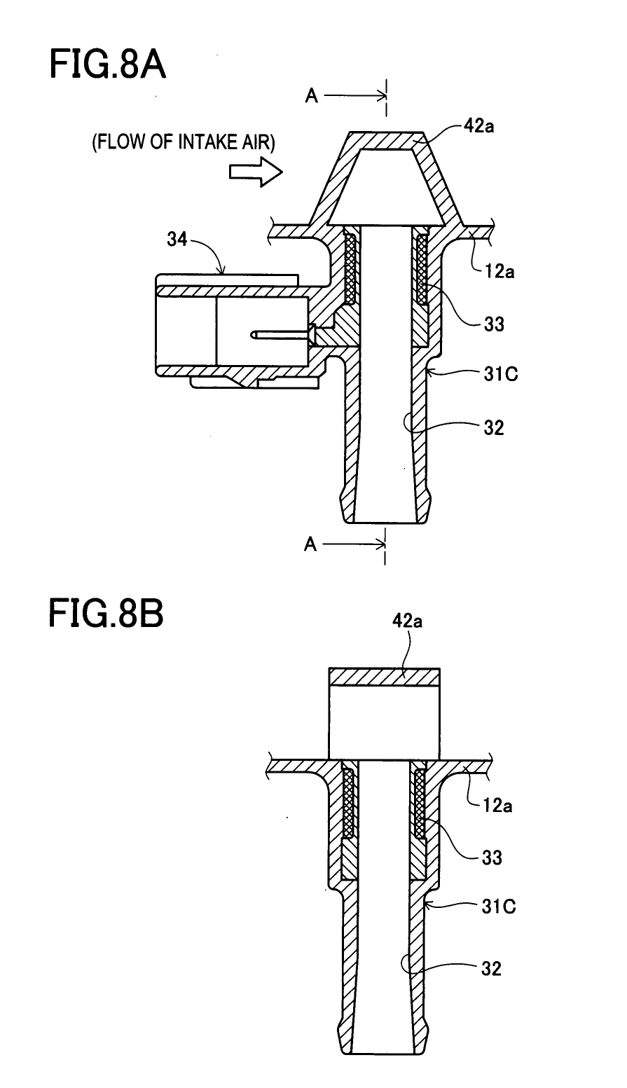

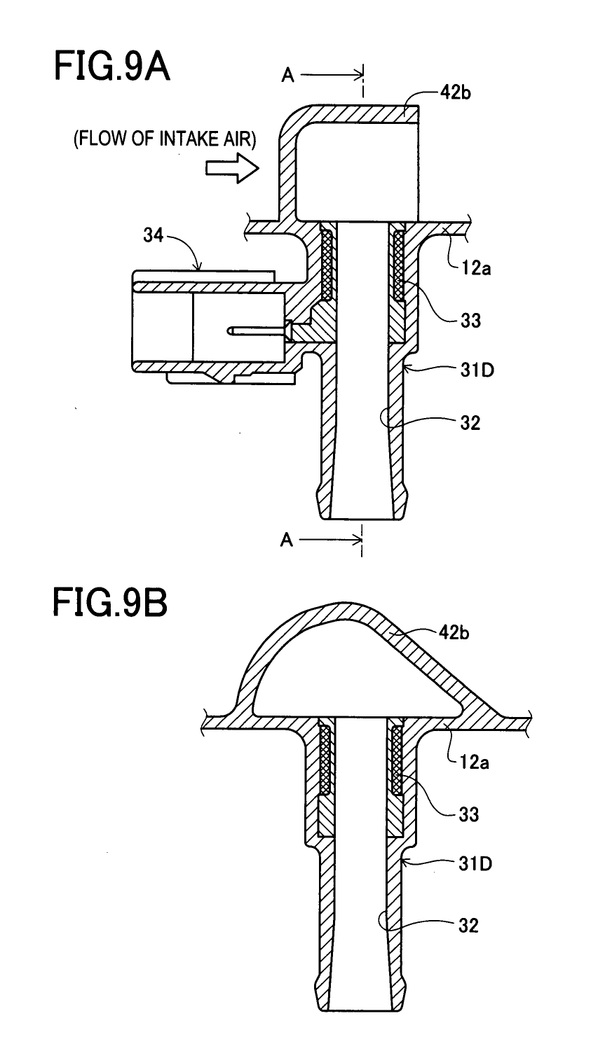

Modified examples of the joint (a blowby gas introducing part) in the first embodiment will be explained below referring to FIGS. 6 through 9. FIG. 6 is a sectional view schematically showing a first modified example of the blowby gas introducing part; FIG. 7A is a sectional view schematically showing a second modified example of the blowby gas introducing part; FIG. 7B is a sectional view of the blowby gas introducing part of FIG. 7A, taken along a line A-A; FIG. 8A is a sectional view schematically showing another example of the second modified example of the blowby gas introducing part; FIG. 8B is a sectional view of the blowby gas introducing part of FIG. 8A, taken along a line A-A; FIG. 9A is a sectional view schematically showing another example of the second modified example of the blowby gas introducing part; FIG. 9B is a sectional view of the blowby gas introducing part of FIG. 9A, taken along a line A-A.

The first modified example is first explained. A joint 31A of the first modified example includes a thermostatic switch 40 in addition to the heater 33. This thermostatic switch 40 is operable to stop energization of the heater 33 when the heater 33 reaches a predetermined temperature (e.g. about 80° C.). For the thermostatic switch 40, a thermistor, a bimetal, and the like may be used.

As above, the joint 31A of the first modified example includes the thermostatic switch 40 arranged to stop energization of the heater 33 when the heater 33 reaches the predetermined temperature. This makes it possible to prevent burning in the intake manifold 12a. In the case where the intake manifold is made of resin, it is also possible to prevent thermal deformation of such resin intake manifold.

The second modified example is explained below. A joint 31B of the second modified example is provided with a protective plate 41 upstream from a blowby gas introducing port as shown in FIGS. 7A and 7B. In the second modified example, this protective plate 41 serves to prevent intake air from directly impinging on the introducing port of the joint 31B. Even when cold intake air flows in the intake passage 12 because the outside air temperature falls to 0° C., the intake air cannot directly impinge on the blowby gas introducing port and does not blow into the blowby gas just flowing from the introducing port, thereby preventing freezing of the water in the blowby gas around the introducing port.

As shown in FIGS. 8A and 8B, a joint 31C is provided with a protective cover 42a (trapezoidal in section, see FIGS. 8A) around the blowby gas introducing port, instead of the protective plate 41. This cover 42a can more reliably prevent intake air from directly impinging on the introducing port. Accordingly, when the cold intake air flows in the intake passage 12 because the outside air temperature falls to 0° C. or any other reasons, it is possible to more reliably prevent freezing of the water in the blowby gas around the introducing port.

Furthermore, as shown in FIGS. 9A and 9B, a joint 31D is provided with a protective cover 42b (streamline in section, see FIG. 9B) around the blowby gas introducing port. This cover 42b can more surely prevent intake air from directly impinging on the introducing port and also minimize intake resistance caused by the cover 42b. Accordingly, even when cold intake air flows in the intake passage 12 because the outside air temperature falls to 0° C., it is possible to more surely prevent freezing of the water in the blowby gas around the introducing port and also restrain the increase in intake resistance. In other words, it is possible to prevent freezing of the water in the blowby gas more reliably while avoiding lowering of engine performance.

### Second Embodiment

Next, a second embodiment will be described. The configuration of the second embodiment is basically identical to that of the first embodiment, excepting a joint formed in a throttle body instead of being formed in an intake manifold. Accordingly, the same components as those in the first embodiment are not repeatedly explained herein. The following explanation will be focused on different features from the first embodiment.

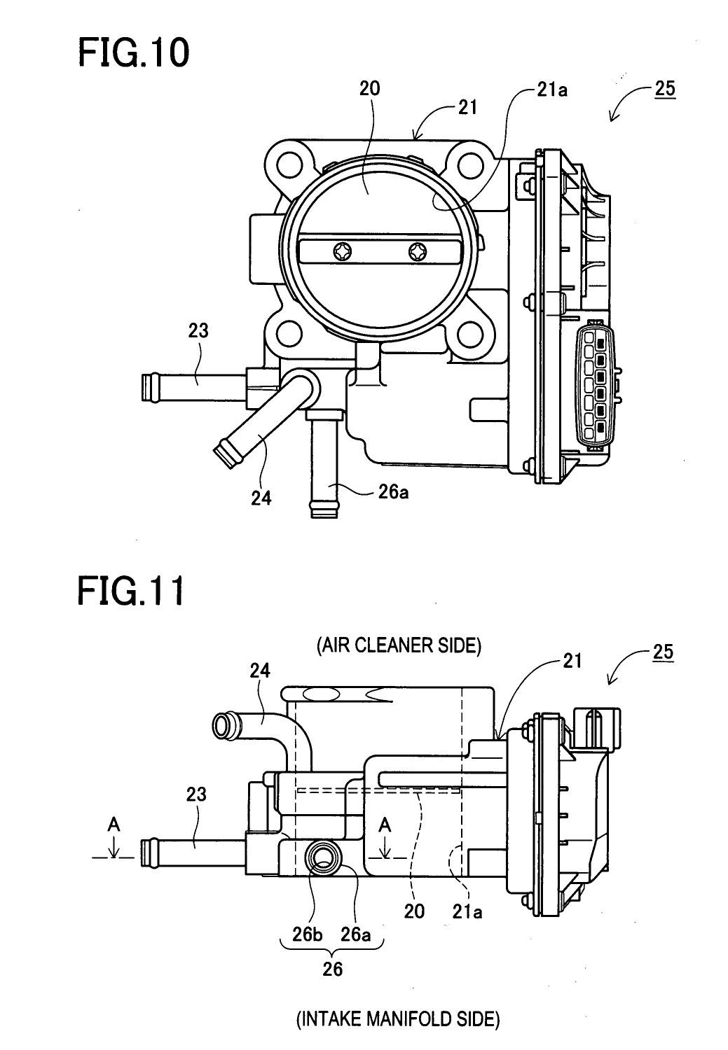

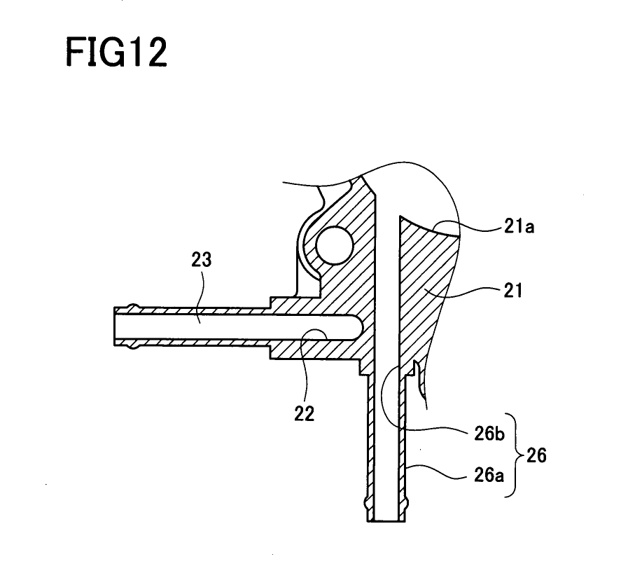

A throttle control apparatus provided with the joint is explained below referring to FIGS. 10 through 12. FIG. 10 is a front view schematically showing the throttle control apparatus, seen from the side of an air cleaner; FIG. 11 is an external view of the throttle control apparatus of FIG. 10, seen from below; and FIG. 12 is a partial sectional view of the throttle control apparatus of FIG. 11, taken along a line A-A.

As a basic configuration, as well known, a throttle control apparatus 25 of the present embodiment includes a throttle body 21, a throttle valve 20 rotatably supported in the throttle body 21, and a drive mechanism (a motor, a gear, etc.) for driving (opening and closing) the throttle valve 20 as shown in FIG. 10. The throttle control apparatus 25 is mounted in some place of an intake pipe.

The throttle body 21 is formed with a bore 21a in which the throttle valve 20 is mounted, and a hot-water pipe 22 for warming the throttle body 21 to prevent the throttle valve 20 from freezing up in the bore 21a. The throttle body 21 is provided with a hot-water introducing port 23 through which hot water is introduced into the hot-water pipe 22 and a hot-water discharging port 24 through which the hot water is discharged from the hot-water pipe.

The throttle body 21 is further formed with a joint 26 which can be connected to the PCV negative pressure passage 30. This joint 26 includes a joint port 26a and a through hole 26b having one end communicating with the bore 21a and the other end opening in the side surface of the throttle body 21. This through hole 26b is arranged near the hot-water pipe 22 as shown in FIG. 12. Thus, the blowby gas passing through the through hole 26b is heated (warmed) by the hot-water flowing in the hot-water pipe 22.

The through hole 26b opens into the bore 21a downstream from the throttle valve 20 as shown in FIG. 11, whereby allowing the blowby gas passing through the PCV negative pressure passage 30 and the joint 26 to flow into the downstream side of the throttle valve.

In the engine system using the throttle control apparatus 25 provided with the above throttle body 21, the blowby gas leaking into the crankcase after the engine 11 starts will pass through the PCV negative pressure passage 30 connected to the head cover 11a and then pass through the join 26 to flow in the bore 21a (part of the intake passage 12) of the throttle body 21. At this time, ventilating air is delivered into the crankcase through the intake passage 12 and the PCV air passage 35. Thus, the blowby gas in the crankcase is caused to smoothly flow from the PCV negative pressure passage 30 to the intake passage 12. The blowby gas flowing in the intake passage 12 is delivered along with a combustible air-fuel mixture into the combustion chamber 13 and burns therein again.

Here, the blowby gas introduced from the PCV negative pressure passage 30 into the intake passage 12 is warmed, while passing through the through hole 26b of the joint 26, by the hot water (engine cooling water) flowing in the hot-water pipe 22. Accordingly, it is possible to prevent freezing of the water in the blowby gas, thereby preventing the PCV negative pressure passage 30 from becoming clogged due to the freezing of the blowby gas.

The blowby gas is introduced into the bore 21a downstream from the throttle valve as above. Accordingly, the blowby gas is unlikely to adhere to the throttle valve 20 and thus the throttle valve 20 can be prevented from freezing due to the water in the blowby gas.

The configuration of the PCV air passage 35 is identical to that in the first embodiment. Accordingly, the blowby gas is not introduced into the intake passage 12 through the PCV air passage 35.

According to the engine system of the second embodiment, as described above, it is possible to warm or heat the blowby gas to be introduced into the intake passage 12 by the hot water flowing in the hot-water pipe 22 of the throttle body 21 without providing any heater unit, so that the same advantages as in the first embodiment can be achieved. Since no heater unit is needed, it is possible to prevent freezing of the water in the blowby gas at low cost to prevent clogging of the PCV negative pressure passage 30 and freezing of the throttle valve 20. Particularly, such an advantage can be achieved largely if the present invention uses the throttle control apparatus initially formed with the hot-water pipe.

The present invention is not limited to the above embodiments and may be embodied in other specific forms without departing from the essential characteristics thereof.

For instance, the check valve 36 provided in the PCV air passage 35 has a fail-safe system in the above embodiments. Alternatively, a general check valve with no fail-safe system may be used. Even when such a check valve with no fail-safe system is used, the above advantages can be achieved.

In the first embodiment, the heater unit used as the heating device may be replaced with the hot-water pipe mentioned in the second embodiment. To the contrary, in the second embodiment, the hot-water pipe used as the heating device may be replaced with the heater unit mentioned in the first embodiment.

While the presently preferred embodiment of the present invention has been shown and described, it is to be understood that this disclosure is for the purpose of illustration and that various changes and modifications may be made without departing from the scope of the invention as set forth in the appended claims.

What is claimed is:

1. A blowby gas passage structure for returning a blowby gas leaking into a crankcase of an internal combustion engine to the internal combustion engine, the blowby gas passage structure comprising:
an intake passage which can be connected to the internal combustion engine for allowing the blowby gas to be returned to the internal combustion engine, and in which a throttle valve is disposed;
a first passage for allowing the blowby gas to be introduced into the intake passage downstream from the throttle valve, the first passage including a joint portion connected to the intake passage; and
a heating device provided in the joint portion of the first passage in such a manner as to be integral with the intake passage.

2. The blowby gas passage structure according to claim 1, wherein
the heating device is provided integral with an intake manifold forming a part of the intake passage.

3. The blowby gas passage structure according to claim 1, wherein
the heating device is a heater unit including a coil wire which can generate heat upon application of an electric current to the coil wire.

4. The blowby gas passage structure according to claim 3, wherein
the heater unit internally holds a thermostatic switch for turning on or off energization of the coil wire according to a heater temperature.

5. The blowby gas passage structure according to claim 1, wherein
the intake passage includes an introducing port for blowby gas and an impinging prevention member formed around the introducing port for preventing intake air from blowing into the blowby gas around the introducing port.

6. The blowby gas passage structure according to claim 5, wherein
the impinging prevention member is a protective plate placed upstream from the introducing port.

7. The blowby gas passage structure according to claim 5, wherein
the impinging prevention member is a cover member arranged to surround the introducing port.

8. The blowby gas passage structure according to claim 1, further comprising a second passage through which ventilating air is introduced from a part of the intake passage disposed upstream from the throttle valve into the crankcase, and
a check valve placed in the second passage for preventing the flow of a fluid from the internal combustion engine to the intake passage.

9. The blowby gas passage structure according to claim 8, wherein
the check valve is provided with a fail-safe system for allowing the fluid to flow from the internal combustion engine to the intake passage when pressure in a part of the second passage closer to the internal combustion engine abnormally rises.

10. A blowby gas passage structure for returning a blowby gas leaking into a crankcase of an internal combustion engine to the internal combustion engine, the blowby gas passage structure comprising:
an intake passage which can be connected to the internal combustion engine for allowing the blowby gas to be returned to the internal combustion engine;
a throttle body having a bore in which a throttle valve is housed;
a first passage for allowing the blowby gas to be introduced into the intake passage downstream from the throttle valve;
a second passage for allowing ventilating air to be introduced from the intake passage upstream of the throttle valve to the crankcase;
a through hole formed opening in a side surface of the throttle body and communicating with the bore; and
a heating device for heating the throttle body;
one end of the first passage being connected to the through hole to introduce the blowby gas from the bore to the intake passage through the through hole.

11. The blowby gas passage structure according to claim 10, wherein the through hole is open into the bore downstream from the throttle valve.

12. The blowby gas passage structure according to claim 10, wherein the heating means is a hot-water pipe formed in the throttle body for allowing cooling water for the internal combustion engine to flow through the pipe.

13. The blowby gas passage structure according to claim 12, wherein the hot-water pipe and the through hole are adjacently arranged in the throttle body.
